(19) United States
(12) Patent Application Publication
(10) Pub. No.: US 2012/0009475 A1
(43) Pub. Date: Jan. 12, 2012

(54) ELECTRODE FOR NON-AQUEOUS ELECTROLYTE SECONDARY BATTERY AND NON-AQUEOUS ELECTROLYTE SECONDARY BATTERY INCLUDING THE SAME

(76) Inventor: Kensuke Nakura, Osaka (JP)

(21) Appl. No.: 13/257,549

(22) PCT Filed: Mar. 3, 2011
(86) PCT No.: PCT/JP2011/001263

§ 371 Date: Sep. 19, 2011

(30) Foreign Application Priority Data
Mar. 15, 2010 (JP) 2010-057848

(51) Int. Cl. H01M 4/131

(52) U.S. Cl. 429/220; 429/209; 429/231.8; 429/218.1; 429/221; 429/223; 429/224; 429/231.5

(57) ABSTRACT

An electrode for a non-aqueous electrolyte secondary battery includes a sheet-like current collector and an active material layer including a first layer and a second layer which are adhering to a surface of the current collector in this order. The first layer includes a carbon material that absorbs or releases lithium ions reversibly at a first potential, while the second layer includes a transition metal oxide that absorbs or releases lithium ions reversibly at a second potential higher than the first potential. The difference between the first potential and the second potential is 0.1 V or more, and the ratio of the thickness T1 of the first layer to the thickness T2 of the second layer, i.e., the ratio T1/T2, is from 0.33 to 75.

### TECHNICAL FIELD

This invention relates to electrodes for non-aqueous electrolyte secondary batteries, and more particularly to an electrode for a non-aqueous electrolyte secondary battery including a plurality of active materials that absorb and release lithium ions at different potentials.

### BACKGROUND ART

Recently, there has been a large demand for non-aqueous electrolyte secondary batteries as the power source for driving portable electronic appliances, hybrid vehicles, electric vehicles, etc. Non-aqueous electrolyte secondary batteries such as lithium ion batteries are light-weight and have high electromotive force and high energy density.

The positive electrode for lithium ion batteries includes, for example, a lithium-containing composite oxide as a positive electrode active material. The negative electrode includes, for example, a carbon material as a negative electrode active material. Among carbon materials, graphite in particular has a high capacity, thereby allowing the battery to have high energy density. Graphite has a layered structure, and during charge, lithium ions are inserted between the layers, i.e., in the interplanar spacings between the (002) faces. During discharge, the lithium ions are extracted from the interplanar spacings.

However, in a low temperature environment, the lithium ion acceptance of even graphite lowers, which may result in insufficient input/output characteristics. If the lithium ion acceptance lowers, lithium may be deposited on the negative electrode surface, thereby resulting in insufficient charge/discharge cycle characteristics. In particular, batteries used as the power source for driving hybrid vehicles and electric vehicles are required to provide high input/output characteristics, and thus their negative electrodes need to be further improved.

PTL 1 proposes laminating a first layer containing graphite and a second layer containing a non-graphitizable carbon material. The first layer is formed on a surface of a current collector, and the second layer is formed on the surface of the first layer. Non-graphitizable carbon materials have small crystallites and large interplanar spacings of the crystallites compared with graphite, and are therefore believed to be superior in lithium ion acceptance to graphite.

Also, in the case of using graphite, the use of propylene carbonate, which is a low melting-point solvent, as a component of the non-aqueous electrolyte may impede charge/discharge due to decomposition of the propylene carbonate on the graphite surface. However, since propylene carbonate has a low viscosity even at low temperatures, the use of propylene carbonate is desirable in terms of enhancing the diffusion of lithium ions in a low temperature environment.

PTL 2 proposes using graphite and amorphous carbon in combination. It is believed that amorphous carbon does not promote the decomposition of propylene carbonate as much as graphite does and can compensate for the drawback of graphite.

PTL 3 proposes using a lithium titanium oxide as a material with good lithium ion acceptance. Since lithium titanium oxides have low conductivity compared with carbon materials, mixing a lithium titanium oxide with a carbon material is commonly examined. However, PTL 3 states that the use of a carbon material and a lithium titanium oxide together in a single battery impedes the absorption and release of lithium ions by the carbon material, thereby making it impossible to obtain a high discharge capacity. Thus, it proposes a power system using a combination of a first battery whose negative electrode includes a carbon material and a second battery whose negative electrode includes a lithium titanium oxide.

### CITATION LIST

### Patent Literature

[PTL 1] Japanese Laid-Open Patent Publication No. 2008-59999
[PTL 2] Japanese Laid-Open Patent Publication No. Hei 8-153514
[PTL 3] Japanese Laid-Open Patent Publication No. 2008-98149

### SUMMARY OF INVENTION

### Technical Problem

Both PTL 1 and PTL 2 use a combination of a plurality of carbon materials to improve the lithium ion acceptance of the negative electrode and low temperature characteristics. However, there is a limit to improvements in lithium ion acceptance of the negative electrode in a low temperature environment and low temperature characteristics, and further improvements are necessary. Also, when a plurality of batteries are combined as in PTL 3, the method for controlling the power system becomes complicated, and the production cost tends to increase.

### Solution to Problem

An aspect of the invention relates to an electrode for a non-aqueous electrolyte secondary battery, including: a sheet-like current collector; and an active material layer including a first layer adhering to a surface of the current collector and a second layer adhering to the first layer. The first layer includes a first active material that absorbs or releases lithium ions reversibly at a first potential, and the first active material includes a carbon material. The second layer includes a second active material that absorbs or releases lithium ions reversibly at a second potential higher than the first potential, and the second active material includes a first transition metal oxide. The difference between the first potential and the second potential is 0.1 V or more, and the ratio of the thickness T1 of the first layer to the thickness T2 of the second layer, i.e., the ratio T1/T2, is from 0.33 to 75.

As used herein, the “first active material that absorbs or releases lithium ions reversibly at a first potential” and the “second active material that absorbs or releases lithium ions reversibly at a second potential” refer to active materials capable of repeatedly absorbing or releasing lithium ions electrochemically, such as materials having capacity densities of 110 mAh/g or more.

Also, the first transition metal oxide is an inorganic material including a transition metal and oxygen, and such materials as phosphates and sulfates of transition metals are included in the first transition metal oxides.

The first potential is preferably less than 1.2 V relative to lithium metal.

The second potential is preferably 0.2 V or more and 3.0 V or less relative to lithium metal, and more preferably 1.2 V or more.

The carbon material preferably has a graphite structure.

The first transition metal oxide preferably has a layered crystal structure or a crystal structure of spinel type, fluorite type, rock salt type, silica type, B₂O₃ type, ReO₃ type, distorted spinel type, Nasicon type, Nasicon analog type, pyrochlore type, distorted rutile type, silicate type, brown millerite type, monoclinic P2/m type, MoO₃ type, trigonal Pnma type, anatase type, ramsdellite type, orthorhombic Pnma type, or perovskite type.

Among materials with a rutile-type or anatase-type crystal structure, such materials as titanium dioxide and rhenium trioxide have low cycle characteristics and, in fact, are not “active materials capable of repeatedly absorbing or releasing lithium ions electrochemically”. Thus, they are excluded from the first transition metal oxides.

The first transition metal oxide is preferably an oxide including at least one transition metal selected from the group consisting of titanium, vanadium, manganese, iron, cobalt, nickel, copper, molybdenum, tungsten and niobium.

The first transition metal oxide is preferably lithium titanate with a spinel-type crystal structure.

The first transition metal oxide preferably has a BET specific surface area of 0.5 to 10 m²/g.

The amount of the second active material contained in the second layer is preferably 2 to 510 parts by weight per 100 parts by weight of the first active material contained in the first layer, and more preferably 3.4 to 170 parts by weight.

Another aspect of the invention relates to a non-aqueous electrolyte secondary battery including: a positive electrode including a second transition metal oxide that absorbs or releases lithium ions at a potential higher than the first transition metal oxide relative to lithium metal; a negative electrode; and a lithium-ion conductive electrolyte layer interposed between the positive electrode and the negative electrode, wherein the negative electrode is the above-mentioned electrode.

### Advantageous Effects of Invention

According to the invention, the lithium ion acceptance of an electrode is improved. It is therefore possible to provide an electrode for a non-aqueous electrolyte secondary battery having good input/output characteristics in a low temperature environment.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 is a schematic longitudinal sectional view of an electrode for a non-aqueous electrolyte secondary battery according to one embodiment of the invention; and

FIG. 2 is a schematic longitudinal sectional view of a non-aqueous electrolyte secondary battery according to one embodiment of the invention.

### DESCRIPTION OF EMBODIMENTS

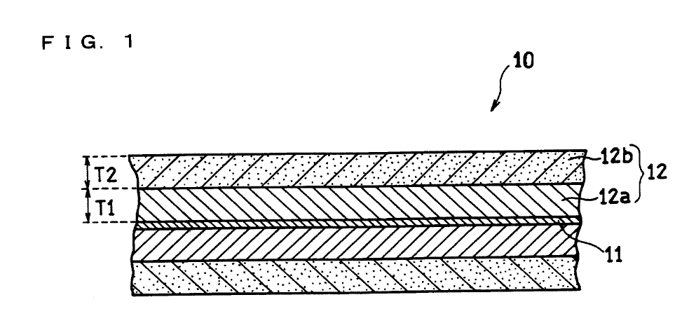

FIG. 1 is a schematic longitudinal sectional view of an electrode 10 for a non-aqueous electrolyte secondary battery according to one embodiment of the invention. The electrode 10 has good lithium ion acceptance. This is probably because an active material layer 12 includes a first layer 12a adhering to a surface of a current collector 11 and a second layer 12b adhering to the first layer 12a, and the potentials at which the respective layers absorb or release lithium ions are optimized. Although the details are not yet known, the diffusion resistance and reaction resistance of the active material layer are believed to be optimized.

The first layer 12a includes a first active material which absorbs or releases lithium ions reversibly at a first potential. The second layer 12b includes a second active material which absorbs or releases lithium ions reversibly at a second potential higher than the first potential. As used herein, the first potential and the second potential refer to the average potential in a relatively flat potential range in which lithium ions are absorbed or released. The average potential as used herein refers to the operational potential, for example, when the SOC (state of charge) is 50%.

The preferable lower limit of the first potential is 0.02 V or 0.05 V relative to lithium metal, and the preferable upper limit is 0.2 V, 1.0 V, or 1.2 V. Any one of the above-mentioned upper limit values and any one of the above-mentioned lower limit values can be combined. For example, the first potential is preferably in the range of 0.02 to 1.2 V.

The preferable lower limit of the second potential is 0.2 V, 1.2 V, or 1.4 V relative to lithium metal, and the preferable upper limit is 1.8 V, 2 V, or 3 V. Any one of the above-mentioned upper limit values and any one of the above-mentioned lower limit values can be combined. For example, the second potential is preferably in the range of 1.2 to 2 V or in the range of 1.5 to 3 V.

When the electrode potential is high relative to lithium metal (in an initial stage of charge for the negative electrode), lithium is more likely to be absorbed by the second layer on the surface side of the whole electrode. Thus, in the electrode in an initial stage of charge, diffusion of lithium becomes easy. On the other hand, when the electrode potential is low relative to lithium metal (in a final stage of charge for the negative electrode), the absorption of lithium by the first layer adjacent to the current collector is promoted. As a result, deposition of lithium on the electrode surface is suppressed.

The reaction resistance of the electrode is high in initial and final stages of charge and initial and final stages of discharge, and is otherwise low and almost constant.

The current collector is preferably a metal foil. When the electrode 10 is a positive electrode, an aluminum foil or aluminum alloy foil is preferable, and when the electrode 10 is a negative electrode, a copper foil, copper alloy foil, or nickel foil is preferable. The thickness of the current collector is, but not particularly limited to, for example, 5 to 30 μm.

A carbon material is used as the first active material contained in the first layer. The carbon material has a low potential relative to lithium metal and is suitable for providing a high capacity, but its lithium ion acceptance tends to lower in a low temperature environment. A first transition metal oxide is used as the second active material contained in the second layer. The first transition metal oxide has high lithium ion acceptance compared with the carbon material, but cannot provide a sufficient capacity when used alone. By laminating the first layer and the second layer, the drawbacks of the carbon material and the first transition metal oxide are mutually compensated for. Further, by disposing the first layer on the current collector side, the diffusion resistance and the reaction resistance are optimized. The content of the carbon material in the first layer is, for example, equal to or more than 80% by weight of the whole first layer.

However, to obtain the above-mentioned effect, the difference between the first potential and the second potential needs to be 0.1 V or more. If the difference between the first potential and the second potential is less than 0.1 V, a sufficient energy density may not be obtained, and the diffusion resistance of the whole electrode is not sufficiently reduced. In terms of providing a higher capacity and reducing the diffusion resistance, the difference between the first potential and the second potential is preferably set to 0.2 V or more, and more preferably 1.2 V or more. However, if the difference between the first potential and the second potential is too large, the charge/discharge control of the battery becomes complicated, so the difference is preferably 1.8 V or less, and more preferably 1.6 V or less.

The ratio of the thickness T1 of the first layer to the thickness T2 of the second layer, i.e., the ratio T1/T2, needs to be from 0.33 to 75. If the T1/T2 ratio is less than 0.33, the amount of the second active material which reacts with lithium ions at a high potential becomes large, and the energy density of the whole electrode becomes low. If the T1/T2 ratio exceeds 75, the amount of the second active material which is superior in input/output characteristics is too small (the second layer is too thin), and the lithium ion acceptance of the whole electrode lowers. Therefore, in a low temperature environment, sufficient input/output characteristics cannot be obtained. The preferable upper limit of the T1/T2 ratio is, for example, 70, 65, 60, or 50, and the preferable lower limit is 1, 5, 10, or 25. Any one of the above-mentioned upper limit values and any one of the above-mentioned lower limit values can be combined, and the preferable range of T1/T2 is, for example, from 1 to 50. Also, when 1 is selected as the preferable lower limit, 5, 10, or 25 may be selected as the preferable upper limit.

The total thickness of the first layer and the second layer is preferably, for example, 40 to 300 μm, and more preferably 45 to 100 μm.

The density of the first layer is preferably 0.9 to 1.7 g/cm³, and more preferably 1.1 to 1.5 g/cm³. The density of the second layer is preferably 1.5 to 3.0 g/cm³, and more preferably 1.7 to 2.7 g/cm³. When the density of each of the first and second layers is within the above-mentioned range, it is easy to optimize the diffusion resistance and reaction resistance of the electrode with good balance while maintaining the high capacity.

The amount of the second active material contained in the second layer is preferably 2 to 510 parts by weight per 100 parts by weight of the first active material contained in the first layer, but is not particularly limited if T1/T2 is from 0.33 to 75. For example, the preferable amount of the second active material per 100 parts by weight of the first active material can be 3.4 to 170 parts by weight. Also, any 100W2/W1 value listed in Examples in Table 1 below may be selected as the upper or lower limit of a preferable range. In such a range, it is easy to optimize the diffusion resistance and reaction resistance of the electrode with good balance while maintaining the high capacity.

The carbon material as the first active material is preferably graphite particles. The use of graphite particles is suitable for providing a high capacity electrode. As used herein, graphite particles generically refer to particles including a region with a graphite structure. Thus, graphite particles include natural graphites, artificial graphites, and graphitized mesophase carbon particles.

The diffraction pattern of graphite particles measured by a wide-angle X-ray diffraction analysis has a peak attributed to the (101) face and a peak attributed to the (100) face. With respect to the ratio of the intensity I(101) of the peak attributed to the (101) face to the intensity I(100) of the peak attributed to the (100) face, preferably 0.01<I(101)/I(100)<0.25, and more preferably 0.08<I(101)/I(100)<0.20. The intensity of the peak as used herein refers to the height of the peak.

The mean particle size (median diameter D₅₀ in volume basis particle size distribution) of the graphite particles is preferably 8 to 25 μm, and more preferably 10 to 20 μm. When the mean particle size is within the above-mentioned range, it is advantageous in that the sliding properties of the graphite particles in the first layer are improved, and the state of the packed graphite particles is good. The volume basis particle size distribution of the graphite particles can be measured, for example, with a commercially available laser diffraction particle size distribution analyzer.

The specific surface area of the graphite particles is preferably 1 to 10 m²/g, and more preferably 3.0 to 4.5 m²/g. When the specific surface area is within the above-mentioned range, it is advantageous in that the sliding properties of the graphite particles in the first layer are improved, and the state of the packed graphite particles is good.

A first transition metal oxide is used as the second active material contained in the second layer. The first transition metal oxide preferably has a layered crystal structure or a crystal structure of spinel type, fluorite type, rock salt type, silica type, B₂O₃ type, ReO₃ type, distorted spinel type, Nasicon type, Nasicon analog type, pyrochlore type, distorted rutile type, silicate type, brown millerite type, monoclinic P2/m type, MoO₃ type, trigonal Pnma type (particularly FePO₄ type), anatase type, ramsdellite type, orthorhombic Pnma type (particularly LiTiOPO₄ type and TiOSO₄ type), or perovskite type. Transition metal oxides with such a crystal structure have high capacity and high stability.

The first transition metal oxide preferably includes at least one transition metal selected from the group consisting of titanium, vanadium, manganese, iron, cobalt, nickel, copper, molybdenum, tungsten, and niobium. For example, titanium containing oxides, iron containing oxides, titanium containing phosphates, and iron containing phosphates are particularly preferable. They can be used singly or in combination. The first transition metal oxide can be freely selected by one with ordinary skill in the art according to the kind of the counter electrode. The content of the first transition metal oxide in the second layer is, for example, not less than 70% or 80% by weight of the whole second layer.

Among transition metal oxides, lithium titanate with a spinel-type crystal structure has a low second potential and is unlikely to impede the absorption and release of lithium ions by the carbon material. Also, lithium titanate has high lithium ion acceptance and is effective for reducing the diffusion resistance of the electrode. Further, lithium titanate itself does not have conductivity, and has high thermal stability compared with the carbon material. Therefore, even in the event that the battery becomes internally short-circuited, a violent current does not flow, and heat production is also suppressed. Therefore, it is preferable as the material contained in the second layer facing the counter electrode.

Lithium titanate with a typical spinel-type crystal structure is represented by the formula Li₄Ti₅O₁₂. However, lithium titanate represented by the general formula LiₓTi_{5-y}M_{y}O_{12+z} can be used as well. In the formula, M is at least one selected from the group consisting of vanadium, manganese, iron, cobalt, nickel, copper, zinc, aluminum, boron, magnesium, calcium, strontium, barium, zirconium, niobium, molybdenum, tungsten, bismuth, sodium, gallium, and rare-earth elements. x is the value of lithium titanate immediately after the synthesis thereof or in a fully discharged state. In the general formula, 3≦x≦5, 0.005≦y≦1.5, and −1≦z≦1. More preferably, M is at least one selected from the group consisting of manganese, iron, cobalt, nickel, copper, aluminum, boron, magnesium, zirconium, niobium, and tungsten.

The mean particle size (median diameter D₅₀ in volume basis particle size distribution) of lithium titanate is preferably 0.8 to 30 μm, and more preferably 1 to 20 μm. When the mean particle size is within the above-mentioned range, lithium ion acceptance tends to become particularly high. The volume basis particle size distribution of lithium titanate can be measured, for example, with a commercially available laser diffraction particle size distribution analyzer.

The BET specific surface area of the first transition metal oxide such as lithium titanate is preferably 0.5 to 10 m²/g, and more preferably 2.5 to 4.5 m²/g. When the specific surface area is within the above-mentioned range, good lithium ion acceptance is exhibited, and good input/output characteristics can be easily obtained even in a low temperature environment.

The second layer can contain not more than 30 parts by weight, for example, 5 to 20 parts by weight, of a carbon material per 100 parts by weight of the first transition metal oxide. The carbon material contained in the second layer is, for example, graphite particles, carbon black, carbon fibers, or carbon nanotubes. The inclusion of a suitable amount of a carbon material in the second layer can provide the second layer with suitable conductivity. It should be noted that the carbon material contained in the second layer may absorb and release lithium ions, but it is not categorized as the second active material herein.

The first layer can contain 0.5 to 10 parts by weight of a binder per 100 parts by weight of the first active material. Likewise, the second layer can contain 0.5 to 10 parts by weight of a binder per 100 parts by weight of the second active material. The binder used in the first layer and the binder used in the second layer may be the same or different. Such binders include, for example, acrylic resins, fluorocarbon resins, and diene rubbers. Examples of acrylic resins include polyacrylic acid, polymethacrylic acid, sodium salts of polyacrylic acid, sodium salts of polymethacrylic acid, and acrylic acid-ethylene copolymers. Examples of fluorocarbon resins include polyvinylidene fluoride (PVDF), polytetrafluoroethylene (PTFE), and vinylidene fluoride-hexafluoropropylene copolymer. A preferable example of diene rubbers is styrene-butadiene copolymer (SBR).

The first layer can contain 0.1 to 5 parts by weight of a thickener per 100 parts by weight of the first active material. Likewise, the second layer can contain 0.1 to 5 parts by weight of a thickener per 100 parts by weight of the second active material. The thickener used in the first layer and the thickener used in the second layer may be the same or different. Such thickeners are preferably water-soluble polymers such as polyethylene oxide or cellulose derivatives. Examples of cellulose derivatives include carboxymethyl cellulose (CMC), methyl cellulose (MC), and cellulose acetate phthalate (CAP).

The electrode of the invention is suited as a negative electrode. The positive electrode to be combined therewith preferably includes a second transition metal oxide that absorbs and releases lithium ions at a potential higher than the first transition metal oxide relative to lithium metal. Typical examples of the second transition metal oxide are, but not limited to, lithium cobaltate, lithium nickelate and lithium manganate.

The lithium-ion conductive electrolyte layer includes a non-aqueous solvent and a lithium salt dissolved in the non-aqueous solvent. The electrolyte layer may include a polyolefin microporous film as a separator, in which case the pores of the microporous film are impregnated with the non-aqueous solvent in which the lithium salt is dissolved. Examples of the non-aqueous solvent include, but are not limited to, ethylene carbonate (EC), propylene carbonate (PC), dimethyl carbonate (DMC), diethyl carbonate (DEC), and ethyl methyl carbonate (EMC). They can be used singly or in combination. Examples of the lithium salt include LiBF₄, LiPF₆, LiAlCl₄, LiCl, and lithium imide salts. They can be used singly or in combination.

The invention is hereinafter described in detail by way of Examples, but Examples are not to be construed as limiting in any way the scope of the invention.

### Example 1

### Preparation of Negative Electrode

### (i) First Negative Electrode Mixture Paste

A first negative electrode mixture paste containing graphite was prepared by stirring 3 kg of artificial graphite (mean particle size 10 μm, BET specific surface area 3 m²/g) serving as a first active material, 200 g of BM-400B of Zeon Corporation (a liquid dispersion of modified styrene-butadiene rubber with a solid content of 40% by weight), 50 g of carboxymethyl cellulose (CMC), and a suitable amount of water with a double-arm kneader. The first negative electrode mixture paste was applied onto both sides of a negative electrode current collector comprising a 10-μm thick copper foil, dried, and rolled to a total thickness of 50 μm to form first layers. That is, the thickness (T1) of the first layer per one side of the copper foil was set to 20 μm, and the density of the first layer was set to 1.3 g/cm³.

### (ii) Second Negative Electrode Mixture Paste

A second negative electrode mixture paste containing lithium titanate was prepared by stirring 2 kg of lithium titanate with a spinel-type crystal structure (Li₄Ti₅O₁₂, mean particle size 1 μm, BET specific surface area 3 m²/g) serving as a second active material, 200 g of artificial graphite (mean particle size 10 μm), 200 g of BM-400B of Zeon Corporation (a liquid dispersion of modified styrene-butadiene rubber with a solid content of 40% by weight), 50 g of carboxymethyl cellulose (CMC), and a suitable amount of water with a double-arm kneader. The second negative electrode mixture paste was applied onto the surface of each of the first layers on both sides of the copper foil, dried, and rolled to a total thickness of 90 μm, to form second layers. That is, the thickness (T2) of the second layer per one side of the copper foil was set to 20 μm, and the density of the second layer was set to 2 g/cm³.

The electrode plate thus obtained was cut to a width such that it was capable of being inserted into a 18650 cylindrical battery case, to obtain a negative electrode. The negative electrode contains 170 parts by weight of lithium titanate (second active material) per 100 parts by weight of graphite (first active material), and T1/T2=1.0.

The first potential (vs Li/Li+) at which the first active material (artificial graphite) absorbs and releases lithium ions is 0.05 V. Also, the second potential (vs Li/Li+) at which the second active material (lithium titanate) absorbs and releases lithium ions is 1.5 V. Thus, the difference between the first potential and the second potential is 1.45 V.

### (Preparation of Positive Electrode)

A positive electrode mixture paste was prepared by stirring 3 kg of lithium cobaltate (mean particle size 10 μm), 1200 g of #1320 of Kureha Corporation, and a suitable amount of N-methyl-2-pyrrolidone (NMP) with a double-arm kneader. The positive electrode mixture paste was applied onto both sides of a positive electrode current collector comprising a 15-μm thick aluminum foil, dried, and rolled to a total thickness of 90 μm, to form positive electrode active material layers.

### (Non-Aqueous Electrolyte)

A non-aqueous electrolyte was prepared by dissolving LiPF₆ at a concentration of 1 mol/liter in a solvent mixture of ethylene carbonate (EC), dimethyl carbonate (DMC), and ethyl methyl carbonate (EMC) in a volume ratio of 1:1:1, and adding vinylene carbonate in an amount corresponding to 3% by weight of the total amount.

### (Assembly of Battery)

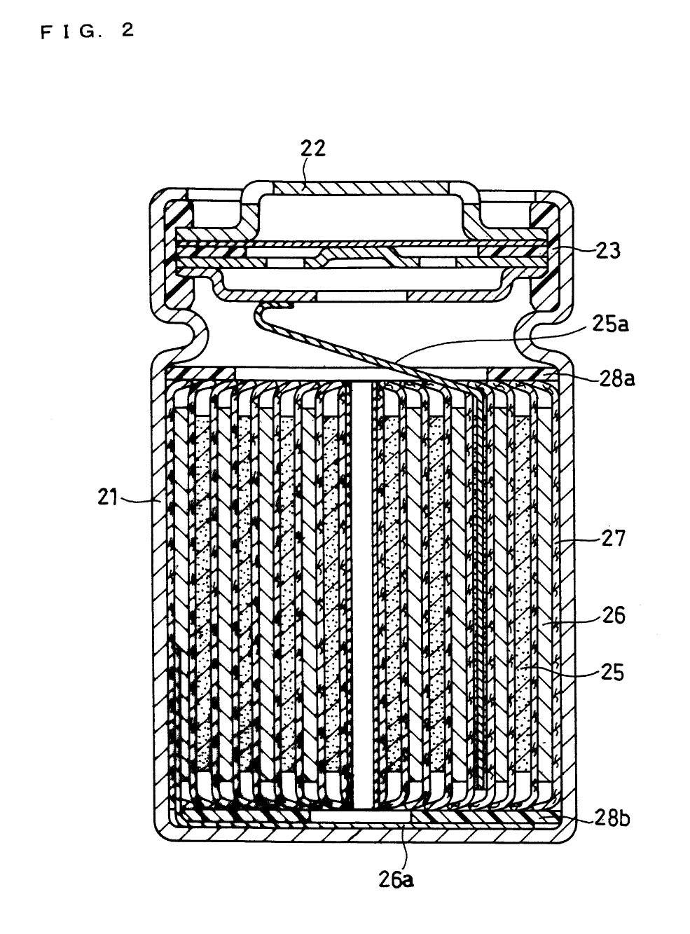

A cylindrical battery illustrated in FIG. 2 was produced.

A separator 27 comprising a 20-μm thick polyethylene microporous film (A089 (trade name) of Celgard K. K.) was interposed between a positive electrode 25 and a negative electrode 26 prepared in the above manner, and they were wound to form a columnar electrode assembly. The electrode assembly was then inserted into a cylindrical iron battery can 21 plated with nickel (inner diameter 18 mm). Insulator plates 28a and 28b were disposed on the upper and lower parts of the electrode assembly, respectively. One end of a positive electrode lead 25a was connected to the positive electrode 25, while the other end was welded to the lower face of a seal plate 22 with a safety valve. One end of a negative electrode lead 26a was connected to the negative electrode 26, while the other end was welded to the inner bottom face of the battery can 21. Thereafter, 5.5 g of the non-aqueous electrolyte was injected into the battery can 21 to impregnate the electrode assembly with the non-aqueous electrolyte. Subsequently, the seal plate 22 was fitted to the opening of the battery can 21, and the open edge of the battery can 21 was crimped onto the circumference of the seal plate 22 with a gasket 23 interposed therebetween. In this manner, a cylindrical non-aqueous electrolyte secondary battery with an inner diameter of 18 mm, a height of 65 mm, and a design capacity of 1300 mAh was completed.

### (Battery Evaluation)

The battery thus obtained was preliminarily charged and discharged twice, and stored in an environment of 45° C. for 7 days. It was then charged and discharged in an environment of 0° C. under the following conditions, to determine the initial discharge capacity.

Constant current charge: Charge current value 1 C/End-of-charge voltage 4.1 V

Constant current discharge: Discharge current value 1.0 C/End-of-discharge voltage 2.5 V

Thereafter, the same charge/discharge was repeated 100 times. The ratio of the discharge capacity at the last cycle to the initial discharge capacity was calculated as capacity retention rate. The result is shown in Table 1 together with the results of Examples and Comparative Examples described below. The amount of lithium titanate (second active material) per 100 parts by weight of graphite (first active material) is shown as 100W2/W1.

TABLE 1

| | | | | | | | Capacity |
|---|---|---|---|---|---|---|---|
| | First | Second | | T1 | T2 | | retention |
| Example | potential | potential | 100W2/W1 | (μm) | (μm) | T1/T2 | rate (%) |
| 1 | 0.05 | 1.5 | 170 | 20 | 20 | 1 | 70 |
| 2 | 0.05 | 1.5 | 2.27 | 300 | 4 | 75 | 70 |
| 3 | 0.05 | 1.5 | 3.4 | 200 | 4 | 50 | 70 |
| 4 | 0.05 | 1.5 | 6.8 | 100 | 4 | 25 | 75 |
| 5 | 0.05 | 1.5 | 17 | 40 | 4 | 10 | 65 |
| 6 | 0.05 | 1.5 | 56.7 | 30 | 10 | 3 | 60 |
| 7 | 0.05 | 1.5 | 68 | 50 | 20 | 2.5 | 60 |
| 8 | 0.05 | 1.5 | 170 | 150 | 150 | 1 | 60 |
| 9 | 0.05 | 1.5 | 425 | 20 | 50 | 0.4 | 50 |
| 10 | 0.05 | 1.5 | 510 | 10 | 30 | 0.33 | 50 |
| Comparative | 0.05 | 1.5 | 1.13 | 5 | 30 | 0.17 | 20 |
| Example 1 | | | | | | | |
| Comparative | 0.05 | 1.5 | 1020 | 300 | 2 | 150 | 15 |
| Example 2 | | | | | | | |
| Comparative | 0.05 | 1.5 | 0 | 40 | 0 | — | 20 |
| Example 3 | | | | | | | |
| Comparative | 0.05 | 1.5 | 6.8 | 100 | 4 | 25 | 10 |
| Example 4 | | | | | | | |
| Comparative | 0.05 | 1.5 | 2.0 | 340 | 4 | 85 | 35 |
| Example 5 | | | | | | | |

### Example 2

A negative electrode was produced in the same manner as in Example 1 except that the thickness T1 of the first layer and the thickness T2 of the second layer were set to 300 μm and 4 μm, respectively, and a cylindrical non-aqueous electrolyte secondary battery was produced and evaluated.

### Example 3

A negative electrode was produced in the same manner as in Example 1 except that the thickness T1 of the first layer and the thickness T2 of the second layer were set to 200 μm and 4 μm, respectively, and a cylindrical non-aqueous electrolyte secondary battery was produced and evaluated.

### Example 4

A negative electrode was produced in the same manner as in Example 1 except that the thickness T1 of the first layer and the thickness T2 of the second layer were set to 100 μm and 4 μm, respectively, and a cylindrical non-aqueous electrolyte secondary battery was produced and evaluated.

### Example 5

A negative electrode was produced in the same manner as in Example 1 except that the thickness T1 of the first layer and the thickness T2 of the second layer were set to 40 μm and 4 μm, respectively, and a cylindrical non-aqueous electrolyte secondary battery was produced and evaluated.

### Example 6

A negative electrode was produced in the same manner as in Example 1 except that the thickness T1 of the first layer and the thickness T2 of the second layer were set to 30 μm and 10 μm, respectively, and a cylindrical non-aqueous electrolyte secondary battery was produced and evaluated.

### Example 7

A negative electrode was produced in the same manner as in Example 1 except that the thickness T1 of the first layer and the thickness T2 of the second layer were set to 50 μm and 20 μm, respectively, and a cylindrical non-aqueous electrolyte secondary battery was produced and evaluated.

### Example 8

A negative electrode was produced in the same manner as in Example 1 except that the thickness T1 of the first layer and the thickness T2 of the second layer were set to 150 μm and 150 μm, respectively, and a cylindrical non-aqueous electrolyte secondary battery was produced and evaluated.

### Example 9

A negative electrode was produced in the same manner as in Example 1 except that the thickness T1 of the first layer and the thickness T2 of the second layer were set to 20 μm and 50 μm, respectively, and a cylindrical non-aqueous electrolyte secondary battery was produced and evaluated.

### Example 10

A negative electrode was produced in the same manner as in Example 1 except that the thickness T1 of the first layer and the thickness T2 of the second layer were set to 10 μm and 30 μm, respectively, and a cylindrical non-aqueous electrolyte secondary battery was produced and evaluated.

### Comparative Example 1

A negative electrode was produced in the same manner as in Example 1 except that the thickness T1 of the first layer and the thickness T2 of the second layer were set to 5 μm and 30 μm, respectively, and a cylindrical non-aqueous electrolyte secondary battery was produced and evaluated.

### Comparative Example 2

A negative electrode was produced in the same manner as in Example 1 except that the thickness T1 of the first layer and the thickness T2 of the second layer were set to 300 μm and 2 μm, respectively, and a cylindrical non-aqueous electrolyte secondary battery was produced and evaluated.

### Comparative Example 3

The first negative electrode mixture paste was applied onto both sides of a negative electrode current collector comprising a 10-μm thick copper foil, dried, and rolled to a total thickness of 90 μm, to form first layers. That is, the thickness (T1) of the first layer per one side of the copper foil was set to 40 μm, and the density of the first layer was set to 1.3 g/cm³. Thereafter, a negative electrode was produced in the same manner as in Example 1 except that no second layer was formed on the surface of each of the first layers, and a cylindrical non-aqueous electrolyte secondary battery was produced and evaluated.

### Comparative Example 4

A negative electrode was produced in the same manner as in Example 4 except that titanium dioxide (TiO₂, mean particle size 1 μm, BET specific surface area 3 m²/g, rutile type) was used instead of lithium titanate (Li₄Ti₅O₁₂, mean particle size 1 μm, BET specific surface area 3 m²/g, hereinafter “lithium titanate (A)”), and a cylindrical non-aqueous electrolyte secondary battery was produced and evaluated.

The results of Table 1 indicate that the range of T1/T2 needs to be 0.33 to 75 and is preferably, for example, 1 to 75.

### Comparative Example 5

A negative electrode was produced in the same manner as in Example 1 except that the thickness T1 of the first layer and the thickness T2 of the second layer were set to 340 μm and 4 μm, respectively, and a cylindrical non-aqueous electrolyte secondary battery was produced and evaluated.

### Example 11

A negative electrode was produced in the same manner as in Example 4 except that monoclinic P2/m type H₂Ti₁₂O₂₅ (mean particle size 1 μm, BET specific surface area 2 m²/g) was used instead of lithium titanate (A), and a cylindrical non-aqueous electrolyte secondary battery was produced and evaluated.

### Example 12

A negative electrode was produced in the same manner as in Example 4 except that ramsdellite type LiTiO₄ (mean particle size 0.5 μm, BET specific surface area 3 m²/g) was used instead of lithium titanate (A), and a cylindrical non-aqueous electrolyte secondary battery was produced and evaluated.

### Example 13

A negative electrode was produced in the same manner as in Example 4 except that spinel type LiTiO₄ (mean particle size 0.5 μm, BET specific surface area 3 m²/g) was used instead of lithium titanate (A), and a cylindrical non-aqueous electrolyte secondary battery was produced and evaluated.

### Example 14

A negative electrode was produced in the same manner as in Example 4 except that anatase type Li_{0.5}TiO₂ (mean particle size 3 μm, BET specific surface area 2 m²/g) was used instead of lithium titanate (A), and a cylindrical non-aqueous electrolyte secondary battery was produced and evaluated.

### Example 15

A negative electrode was produced in the same manner as in Example 4 except that trigonal Pnma type FePO₄ (mean particle size 1 μm, BET specific surface area 2 m²/g) was used instead of lithium titanate (A), and a cylindrical non-aqueous electrolyte secondary battery was produced and evaluated.

### Example 16

A negative electrode was produced in the same manner as in Example 4 except that Nasicon type Li₃Fe₂(PO₄)₃ (mean particle size 0.5 μm, BET specific surface area 4 m²/g) was used instead of lithium titanate (A), and a cylindrical non-aqueous electrolyte secondary battery was produced and evaluated.

### Example 17

A negative electrode was produced in the same manner as in Example 4 except that Nasicon type LiTi₂(PO₄)₃ (mean particle size 0.4 μm, BET specific surface area 3 m²/g) was used instead of lithium titanate (A), and a cylindrical non-aqueous electrolyte secondary battery was produced and evaluated.

### Example 18

A negative electrode was produced in the same manner as in Example 4 except that orthorhombic Pnma type LiTiOPO₄ (mean particle size 1 μm, BET specific surface area 3 m²/g) was used instead of lithium titanate (A), and a cylindrical non-aqueous electrolyte secondary battery was produced and evaluated.

### Example 19

A negative electrode was produced in the same manner as in Example 4 except that orthorhombic Pnma type TiOSO₄ (mean particle size 0.5 μm, BET specific surface area 2 m²/g) was used instead of lithium titanate (A), and a cylindrical non-aqueous electrolyte secondary battery was produced and evaluated.

Table 2 shows the results of Examples 11 to 19.

TABLE 2

| | | | | | | | Capacity |
|---|---|---|---|---|---|---|---|
| | First | Second | | T1 | T2 | | retention |
| Example | potential | potential | 100W2/W1 | (μm) | (μm) | T1/T2 | rate (%) |
| 11 | 0.05 | 1.5 | 5.4 | 100 | 4 | 25 | 70 |
| 12 | 0.05 | 1.5 | 9.5 | 100 | 4 | 25 | 65 |
| 13 | 0.05 | 1.5 | 9.5 | 100 | 4 | 25 | 65 |
| 14 | 0.05 | 1.5 | 9.5 | 100 | 4 | 25 | 70 |
| 15 | 0.05 | 3.0 | 6.8 | 100 | 4 | 25 | 60 |
| 16 | 0.05 | 2.8 | 9.2 | 100 | 4 | 25 | 60 |
| 17 | 0.05 | 2.5 | 9.2 | 100 | 4 | 25 | 65 |
| 18 | 0.05 | 1.6 | 7.5 | 100 | 4 | 25 | 70 |
| 19 | 0.05 | 2.5 | 9.5 | 100 | 4 | 25 | 70 |

The results of Table 2 indicate that not only lithium titanate but also electrochemically active materials having various crystal structures (first transition metal oxides) can be used as the second active materials.

### INDUSTRIAL APPLICABILITY

Secondary batteries using the electrodes for non-aqueous electrolyte secondary batteries according to the invention are particularly suited for applications in which input/output characteristics in a low temperature environment are required, but their applications are not particularly limited. For example, the non-aqueous electrolyte secondary batteries according to the invention can be used as the power source for portable electronic appliances such as cellular phones, notebook personal computers, and digital cameras, hybrid vehicles, electric vehicles, and power tools.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

10 Electrode
11 Current Collector
12 Active Material Layer
12a First Layer
12b Second Layer
21 Battery Can
22 Seal Plate
23 Gasket
25 Positive Electrode
25a Positive Electrode Lead
26 Negative Electrode
26a Negative Electrode Lead
27 Separator
28a, 28b Insulator Plate

1. An electrode for a non-aqueous electrolyte secondary battery, comprising:
a sheet-like current collector; and
an active material layer including a first layer adhering to a surface of the current collector and a second layer adhering to the first layer,
the first layer including a first active material that absorbs or releases lithium ions reversibly at a first potential, the first active material comprising a carbon material,
the second layer including a second active material that absorbs or releases lithium ions reversibly at a second potential higher than the first potential, the second active material comprising a first transition metal oxide,
the difference between the first potential and the second potential being 0.1 V or more, and
the ratio of the thickness T1 of the first layer to the thickness T2 of the second layer, i.e., the ratio T1/T2, being from 0.33 to 75.

2. The electrode for a non-aqueous electrolyte secondary battery in accordance with claim 1,
wherein the first potential is less than 1.2 V relative to lithium metal, and
the second potential is 0.2 V or more and 3.0 V or less relative to lithium metal.

3. The electrode for a non-aqueous electrolyte secondary battery in accordance with claim 1, wherein the carbon material has a graphite structure.

4. The electrode for a non-aqueous electrolyte secondary battery in accordance with claim 1, wherein the first transition metal oxide has a layered crystal structure or a crystal structure of spinel type, fluorite type, rock salt type, silica type, B₂O₃ type, ReO₃ type, distorted spinel type, Nasicon type, Nasicon analog type, pyrochlore type, distorted rutile type, silicate type, brown millerite type, monoclinic P2/m type, MoO₃ type, trigonal Pnma type, anatase type, ramsdellite type, orthorhombic Pnma type, or perovskite type.

5. The electrode for a non-aqueous electrolyte secondary battery in accordance with claim 1, wherein the first transition metal oxide is an oxide including at least one transition metal selected from the group consisting of titanium, vanadium, manganese, iron, cobalt, nickel, copper, molybdenum, tungsten and niobium.

6. The electrode for a non-aqueous electrolyte secondary battery in accordance with claim 5, wherein the first transition metal oxide is at least one selected from the group consisting of titanium containing oxides, iron containing oxides, titanium containing phosphates, and iron containing phosphates.

7. The electrode for a non-aqueous electrolyte secondary battery in accordance with claim 5, wherein the first transition metal oxide is lithium titanate with a spinel-type crystal structure.

8. The electrode for a non-aqueous electrolyte secondary battery in accordance with claim 1, wherein the first transition metal oxide has a BET specific surface area of 0.5 to 10 m²/g.

9. The electrode for a non-aqueous electrolyte secondary battery in accordance with claim 1, wherein the amount of the second active material contained in the second layer is 2 to 510 parts by weight per 100 parts by weight of the first active material contained in the first layer.

10. A non-aqueous electrolyte secondary battery comprising:
a positive electrode including a second transition metal oxide that absorbs or releases lithium ions at a potential higher than the first transition metal oxide relative to lithium metal;
a negative electrode; and
a lithium-ion conductive electrolyte layer interposed between the positive electrode and the negative electrode,
wherein the negative electrode is the electrode of claim 1.
